(19) United States
(12) Patent Application Publication
(10) Pub. No.: US 2017/0054983 A1
(43) Pub. Date: Feb. 23, 2017

(54) METHOD AND APPARATUS FOR ENCODING AND DECODING DIGITAL DATA IN AN IMAGE

(71) Applicant: SOUL PURPOSE LIMITED, Coventry (GB)

(72) Inventors: Paul Gilligan, Warwickshire (GB); James Clyne, Warwickshire (GB)

(73) Assignee: Soul Purpose Limited, Coventry (GB)

(21) Appl. No.: 15/118,761

(22) PCT Filed: Feb. 12, 2015
(86) PCT No.: PCT/GB2015/050387

§ 371 Date: Aug. 12, 2016

(30) Foreign Application Priority Data
Feb. 13, 2014 (GB) 1402565.4

(51) Int. Cl. H04N 19/136; G06T 7/00; H04N 19/44; H04N 19/167

(52) U.S. Cl. CPC H04N 19/136; H04N 19/167; G06T 7/0085; H04N 19/44

(57) ABSTRACT

A method and apparatus for generating an image to encode digital data to be computer readable is disclosed. The method and apparatus defines a spatial reference object configuration within an encoding region; defines a shape and size of the encoding region by defining a boundary around the spatial reference object configuration; determines relative spatial properties for a plurality of coding objects to be displayed in the image based on the digital data and the spatial reference object configuration; and generates an image of the coding objects spatially arranged in the encoding region around the spatial reference object configuration in accordance with the determined spatial properties, wherein the spatial reference object configuration is distinctive compared to the coding objects. Also a method and apparatus for decoding digital data in an image is disclosed. The method and apparatus analyzes the image to identify a distinctive spatial reference object configuration in an encoding region of the image, the image comprising the spatial reference object configuration and coding objects in the coding region around the spatial reference object configuration; determines a spatial reference using the spatial reference object configuration; analyzes the image to identify a plurality of coding objects in the encoding region; determines relative spatial properties for the coding objects with reference to the spatial reference object configuration; and decodes the digital data from the spatial properties determined for the coding objects.

### FIELD OF THE INVENTION

The present invention relates to a method and apparatus for encoding and decoding digital data in an image.

### BACKGROUND INFORMATION

It is well known to encode data in an image so that it can be recognized and read by a computing apparatus with a suitable imaging capability, such as a digital camera or scanner. Barcodes are examples of such images. Linear or one-dimensional barcodes are widely used for goods to carry data identifying the goods. Two-dimensional barcodes are also used for encoding information. Two-dimensional barcodes are capable of encoding much more information than one-dimensional barcodes and they are formed as a grid or matrix of black and white elements in a square reference frame with reference marks arranges at corners. An advanced form of a two dimensional barcode is the Microsoft Tag™. This allows the encoded pattern to be stylized considerably compared to a traditional two-dimensional barcode. However, it still encodes data in a rectangular or hexagonal grid or matrix with reference points arranges in a frame or boundary around the encoding region. The grid and the boundary reference points constrain the stylization possibilities for images encoded with digital information.

### SUMMARY OF THE INVENTION

One aspect provides a method of generating an image to encode digital data to be computer readable, the method comprising defining a spatial reference object configuration within an encoding region; defines a shape and/or size of the encoding region by defining a boundary around the spatial reference object configuration; determining relative spatial properties for a plurality of coding objects to be displayed in the image based on the digital data and the spatial reference object configuration; and generating an image of the coding objects spatially arranged within the boundary of the encoding region around the spatial reference object configuration in accordance with the determined spatial properties, wherein the spatial reference object configuration is distinctive compared to the coding objects.

Another aspect provides a computer apparatus for generating an image to encode digital data to be computer readable, the apparatus comprising a program code store storing program code; and a processor for reading the program code in the code store; wherein the program code in the code store comprises code for controlling the processor to define a spatial reference object configuration within an encoding region; code for controlling the processor to define a shape and/or size of the encoding region by defining a boundary around the spatial reference object configuration code for controlling the processor to determine relative spatial properties for a plurality of coding objects to be displayed in the image based on the digital data and the spatial reference object configuration; and code for controlling the processor to generate an image of the coding objects spatially arranged within the boundary of the encoding region around the spatial reference object configuration in accordance with the determined spatial properties, wherein the spatial reference object configuration is distinctive compared to the coding objects.

Another aspect provides a method of decoding digital data in an image, the method comprising analyzing the image to identify a distinctive spatial reference object configuration in an encoding region of the image, the shape and size of which is defined by a boundary around the spatial reference object configuration, the image comprising the spatial reference object configuration and coding objects in the coding region around the spatial reference object configuration; determining a spatial reference using the spatial reference object configuration; analyzing the image to identify a plurality of coding objects in the encoding region; determining relative spatial properties for the coding objects with reference to the spatial reference object configuration; and decoding the digital data from the spatial properties determined for the coding objects.

Another aspect provides a computer apparatus for decoding digital data in an image, the computer apparatus comprising a program code store storing program code; and a processor for reading the program code in the code store; wherein the program code in the code store comprises code for controlling the processor to analyze the image to identify a distinctive spatial reference object configuration in an encoding region of the image, the shape and size of which is defined by a boundary around the spatial reference object configuration, the image comprising the spatial reference object configuration and coding objects in the coding region around the spatial reference object configuration; code for controlling the processor to determine a spatial reference using the spatial reference object configuration; code for controlling the processor to analyze the image to identify a plurality of coding objects in the encoding region; code for controlling the processor to determine relative spatial properties for the coding objects with reference to the spatial reference object configuration; and code for controlling the processor to decode the digital data from the spatial properties determined for the coding objects.

Another aspect provides apparatus for generating an image to encode digital data to be computer readable, the apparatus comprising means for defining a spatial reference object configuration within an encoding region; means for defining a shape and/or size of the encoding region by defining a boundary around the spatial reference object configuration; means for determining relative spatial properties for a plurality of coding objects to be displayed in the image based on the digital data and the spatial reference object configuration; and means for generating an image of the coding objects spatially arranged in the encoding region around the spatial reference object configuration in accordance with the determined spatial properties, wherein the spatial reference object configuration is distinctive compared to the coding objects.

Another aspect provides apparatus for decoding digital data in an image, the apparatus comprising means for analyzing the image to identify a distinctive spatial reference object configuration in an encoding region of the image, the shape and size of which is defined by a boundary around the spatial reference object configuration, the image comprising the spatial reference object configuration and coding objects in the coding region around the spatial reference object configuration; means for determining a spatial reference using the spatial reference object configuration; means for analyzing the image to identify a plurality of coding objects in the encoding region; means for determining relative spatial properties for the coding objects with reference to the spatial reference object configuration; and means for decoding the digital data from the spatial properties determined for the coding objects.

### BRIEF DESCRIPTION OF THE DRAWINGS

FIG. 1 is a schematic diagram illustrating an image encoding digital data according to one embodiment;

FIG. 2 is a flow diagram of the process for encoding digital data in an image according to one embodiment;

FIG. 3 is a flow diagram of the process for decoding digital data in an image according to one embodiment;

FIG. 4 is a flow diagram of alternative steps in the process for decoding digital data in an image according to one embodiment;

FIG. 5 is a flow diagram of alternative steps in the process for decoding digital data in an image according to one embodiment;

FIG. 6 is a flow diagram of alternative steps in the process for decoding digital data in an image according to one embodiment;

FIG. 7 is a diagram illustrating the geometry used to identify the reference object configuration according to the embodiment of FIG. 6;

FIG. 8 is a flow diagram of alternative steps in the process for decoding digital data in an image according to one embodiment;

FIG. 9 is a schematic diagram of an apparatus for use in decoding the digital data in an image and/or for encoding digital data in an image according to one embodiment;

FIGS. 10 to 14 are examples of encoded images according to embodiments;

FIG. 15 is an example of an encoded image showing the use of null encoding objects to form an image according to one embodiment; and

FIG. 16 is an example of an alternative encoded image in which the image is encoded with a single reference object and with radial symmetry according to one embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labeled with like reference numerals.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

A generalized embodiment provides for the encoding and decoding of digital data or information in an image which is not constrained by a fixed reference boundary or by a grid or matrix layout as in the prior art. A spatial reference configuration is provided within a bounded region of the image in which the encoded image is provided so that the spatial reference configuration is combined with the encoded data in the image. A boundary around the region can be defined to define a chosen or selected shape and size of the encoding region. A pattern of coding objects is provided in the encoding region to be recognized with reference to the spatial reference configuration. In this way, variations in the orientation and magnification of the image can be compensated for since the spatial reference will provide a scaling and angular reference. The coding objects can be arranged around or interspersed with the spatial reference configuration. The shape of the boundary can be chosen to enable flexibility in the design of the visible code region.

The spatial reference based on location defines one or more points in space. These can be indicated by spatial reference objects, which comprise displayed shapes or images. The points in space can be determined from these as points in a common relative position in the shape or image e.g. in the centre of the object.

A set of unique digital data values can be encoded as a set of unique codes represented as spatially configured coding objects in the encoding region. Hence, the relative spatial properties represented by the coding objects define dimensions in a multidimensional encoding space into which the digital data can be encoded and from which digital data can be decoded, with each unique data value or item being represented by a unique point in the multidimensional space.

The dimensionality of the encoding space is defined by the number of unique spatial features that can distinguish each of the coding objects. The spatial arrangements of the coding objects (and hence the dimensionality of the encoding space) can be defined by the location of the coding objects, which can be defined by coordinates in any coordinate system e.g. Cartesian or polar coordinates and the relative location can be defined by a distance and angle from the reference location provided by the spatial reference configuration. A distinctive feature to distinguish coding objects can also or alternatively be the shape (or an image), size, orientation or colour of the coding objects. The choice of feature represents a choice of the encoding type to be used. Any combination of these can be used and could be selected by a user for encoding data to generate encoded images with different styles. This gives the user an element of choice in the design and appearance of the image.

The lack of a required fixed reference boundary provides the designer of the encoded image with a greater design freedom. The designed can design a bespoke boundary to confine the encoding region in a desired region or shape. The boundary can be invisible or it can be displayed in the image. Hence, the boundary plays no part in the encoding or decoding of the data. It simply serves a design function to enable a designer to define the region in which the coding objects and reference objects (and any null objects) appear.

To assist with creating an encoded region with a desired appearance, null objects can be defined and used in the image. Null objects are objects that do not encode any data. A single null object design could be defined and used or several. In the generation of the image, after the relative spatial arrangement of the coding objects in the encoding region, null objects can be included in the image to enhance the image e.g. to infill regions of the encoding region to create images or shapes. The null objects can have a similar appearance to the coding objects e.g. a similar shape, size, colour and/or orientation. The ability to use subtly different null objects in the encoding region, together with the selection of the boundary shape and size, enables designers to create encoded images that have aesthetic qualities.

The spatial reference object configuration can be selected by a user to be unique to a user or company for example. When decoding, the spatial reference configuration can be detected as being one of a known number. Hence, the spatial reference object configuration effectively encodes information and can be used to direct the decoding process to operate in accordance with a known encoding used by the user or company.

The encoded image of embodiments can be provided as a digital image e.g. on a computer screen, a video, or a digital photograph, or it can be applied to a physical object e.g. printed on paper or any other object.

The encoded image can be either directly processed by a computer where the image is in digital form or it can be digitized by a suitable device, such as a camera or a scanner, where the image is applied to a physical object to allow the encoded data in the image to be decoded by a computer.

In the embodiments, the processing to encode or decode an image can be performed by any suitable computing device including a personal computer, a tablet computer, a personal digital assistant, a laptop computer, a mobile telephone, a smart phone, etc. A mobile device such as a smart phone with an in built camera is particularly suited for capturing, recognizing and decoding data in an encoded image.

Specific embodiments will now be described with reference to the drawings.

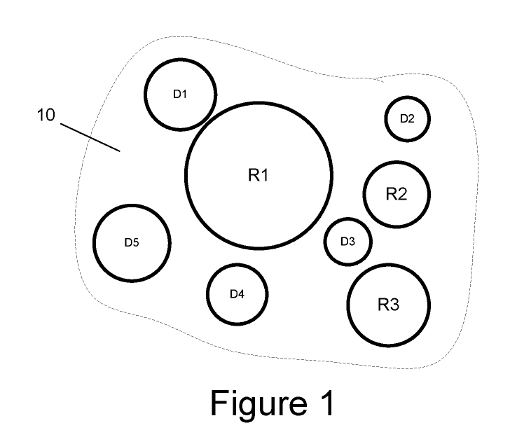

FIG. 1 illustrates an encoded image according to one embodiment. In this encoded image, a spatial reference object configuration comprises three spatial reference objects R1, R2 and R3. Interspersed with these reference objects are coded objects D1 to D5. The reference objects and the coded objects are all arranged in the encoded region 10 with a chosen boundary indicated by the dashed line in the drawing. The indication of the boundary of the encoded region need not be displayed in the encoded image.

In the embodiment of FIG. 1, the coding objects D1 to D5 comprise line drawn circles. Their size and relative location encodes the data. Relative location can provide two encoding dimensions defined by distance and direction or angle. The relative size provides another dimension for encoding data.

The spatial reference objects R1, R2 and R3 are provide in a spatial relationship, which is known. They lie in positions defining apices of a triangle. The orientation of this triangle defines the reference orientation to compensate for changes in orientation. The distances between the reference objects defines the scaling of the image and can be used in the processing to compensate for magnification changes.

In FIG. 1 the reference objects R1, R2 and R3 are of different sizes. In this embodiment, to identify the reference objects uniquely, the reference objects could all have unique sizes i.e. sizes that are not used for any coding objects. Alternatively, their relative sizes are unique to enable them to be uniquely identified as reference objects.

It can be seen in the embodiment of FIG. 1 that the reference objects and the coding objects are mixed up in the encoding region 10. This avoids the need for a reference frame and enables the image to be stylized greatly. This also however requires the reference objects to be uniquely identifiable to be distinguished from the coding objects.

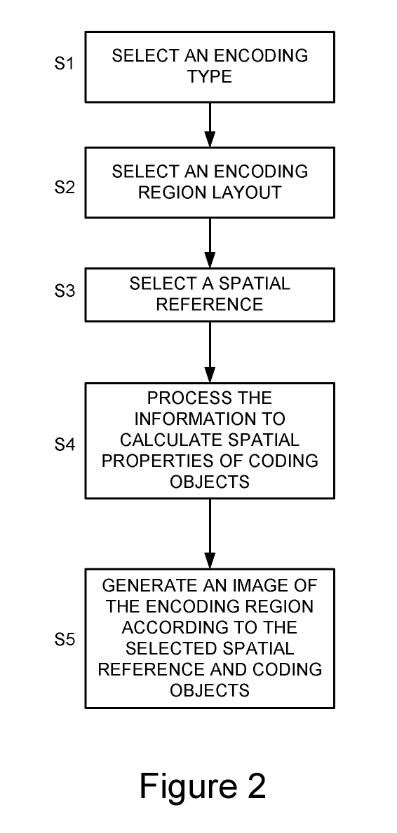

The process for encoding data in an image will now be described with reference to the flow diagram of FIG. 2.

In step S1, the designer of the encoded image can select the type of encoding to be used for the image generation. A designer can select to use a single shape or multiple shapes of coding objects, a single colour or multiple colours of coding objects, a single orientation or multiple orientations of a symmetric shape of coding objects, and/or a single size or multiple sizes of coding objects. For example, a designer can be presented with a list of style options, where each style defines a type of encoding.

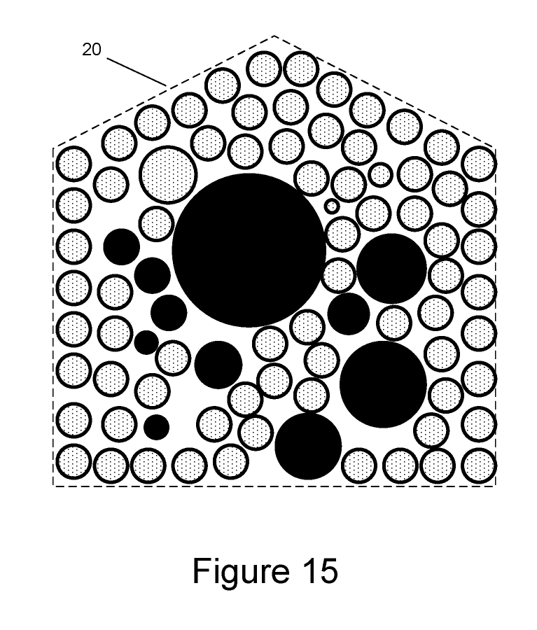

In step S2, the designer can select the encoding region layout by selecting an encoding region boundary shape (and whether or not to display a boundary marker) and an infill style using null objects. The designer can select one or any number of null objects. Increasing the number of types of null objects reduces the encoding capacity of the design since each type of null object used removes the possibility of that object encoding data since null objects need to be recognized distinctly from coding objects. The use of null objects will be described in more detail with reference to FIG. 15.

In step S3, the designer can select a spatial reference configuration to be used. The spatial reference configuration can comprise any number of reference objects and the size and shape of the reference objects can be selected. A spatial reference configuration can act like a signature for an encoded image. It will be consistent within a set of encoded images using the same encoding type to encode digital data. It can hence be used to identify the originator of the encoded image. To decode the image, the decoder needs to know what type of encoding is used and what spatial reference configuration was used in the encoding. To decode, a decoder will be provided with knowledge of the encoding type and the spatial reference configuration. The capacity of the encoding technique to allow personalization enables an organization to define their own encoding type and encoding region layout. The encoding type and encoding region layout can be selected to cause all the encoded images generated according to the type and layout to be of a certain style or appearance, which may be chosen according to the branding of an organization or to impart a message to the viewer.

The encoding comprises mapping digital data to spatial coordinates. Hence the process can be performed using a look up table operation or by a mapping algorithm to convert from ‘data space’ to spatial coordinates.

Steps S1, S2 and S3 can be used in any combination or alone. For example, any of the encoding type, the encoding region layout of the spatial reference may be predefined and not selectable by a user.

In step S4 the digital data or information is processed to calculate spatial properties for the coding objects. The spatial properties of the coding objects can comprise the location, size, colour, shape or orientation of the objects with reference to the spatial reference configuration and each other.

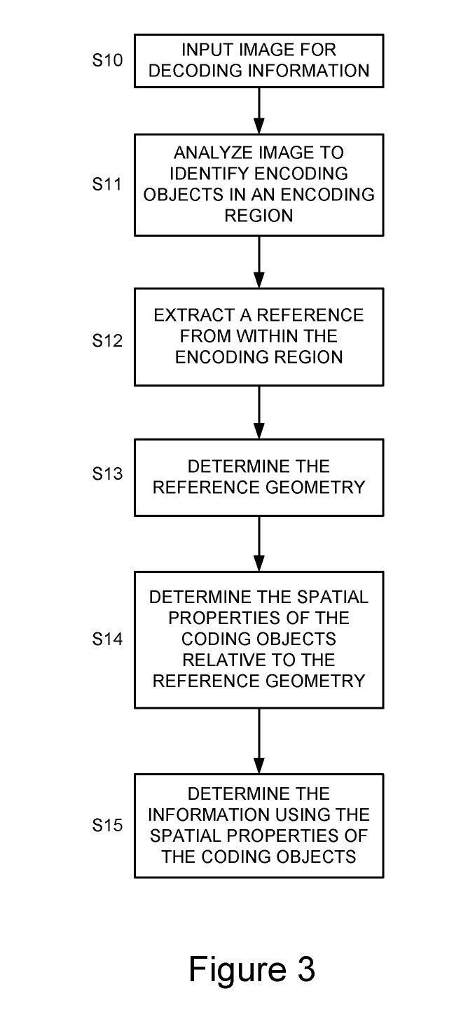

The process for decoding data in an image will now be described with reference to the flow diagram of FIG. 3.

The process begins in step S10 with the inputting of an image for decoding. The image can be captured by an image capture device such as a digital camera or scanner or it can be provided electronically or extracted from a digital image.

In step S11, the image is analyzed to identify objects in an encoding region. The objects comprise coding objects, null objects, and spatial reference objects. The extraction is performed using an image recognition process. Such processes for identifying different objects in an image are well known in the art.

In step S12, the spatial reference configuration is identified and extracted from within the encoding region and in step S13 the reference geometry is determined. This provides the spatial reference to be used to decode spatial properties of the identified coding objects in steps S14. The spatial properties can comprise one or more of location, size, shape, colour or orientation of the objects.

In step S15, the digital data (information) encoded in the image is decoded using the determined spatial properties of the identified coding objects. The decoding comprises mapping spatial coordinates to digital data. Hence, the process can be performed using a look up table operation or by a mapping algorithm to convert from spatial coordinates to ‘data space’.

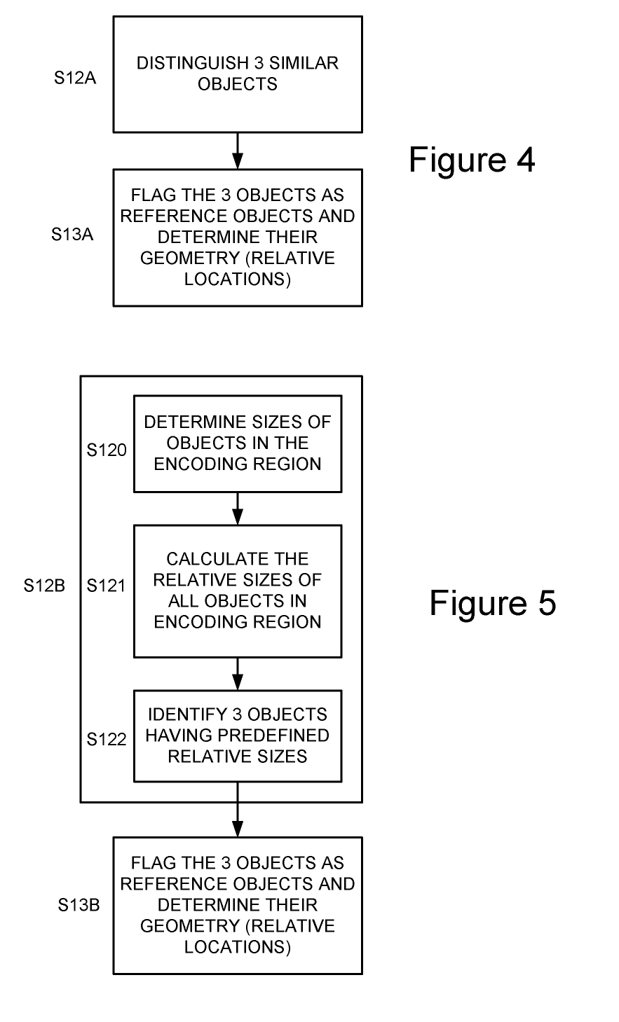

FIG. 4 is a partial flow diagram illustrating alternative steps for steps S12 and S13 in FIG. 3.

In step S12A, the reference objects are extracted from the encoding region of the image by distinguishing three similar or identical objects having the same spatial parameters apart from location i.e. any of the same shape, size, colour or orientation. In order for this to be possible, the spatial reference objects must be unique in size and the encoding process must not encode the digital data to create three coding objects that are of the same size in the encoding area. This does provide a restriction on the encoding possibilities. This restriction could be relaxed by specifying reference objects within a certain size range but this does then place the requirement on being able to obtain reference size information from the encoding region e.g. from the size of the encoding region given by the area occupied by the coding and reference objects.

In step S13A, the three extracted objects are defined as reference objects and their geometry is determined. The geometry in this embodiment comprises their relative locations. The locations of the reference objects can be determined as point at a common position in the object e.g. in the centre. The relative locations provide information on the orientation of the encoding region. The three reference objects lie in a triangle and the orientation of this triangle can be used as a reference coordinate system for the determination of the locations (and where appropriate orientations) of the coding objects.

FIG. 5 is a partial flow diagram illustrating other alternative steps for steps S12 and S13 in FIG. 3.

Step S12 in FIG. 3 is replaced with step S12B in this embodiment, which comprises three steps, S120, S121 and S122. In step S120, the sizes of the objects in the encoding region are determined and in step S121, the relative sizes of all of the objects in the encoding region is calculated. For example, for three objects having size X, Y and Z, the relative sizes can be calculated as X/Y, X/Z and Y/Z. The spatial reference objects are identified by identifying three objects having predefined relative sizes in steps S122. In order for this to be possible, the spatial reference objects must be unique in relative size and the encoding process must not encode the digital data to create three coding objects that have the same relative size in the encoding area. This does provide a slight restriction on the encoding possibilities. The use of relative avoids the need for a reference size and compensates for scaling and magnification.

In step S13B, the three extracted objects are defined as reference objects and their geometry is determined. The geometry in this embodiment comprises their relative locations. The locations of the reference objects can be determined as point at a common position in the object e.g. in the centre. The relative locations provide information on the orientation of the encoding region. The three reference objects lie in a triangle and the orientation of this triangle can be used as a reference coordinate system for the determination of the locations (and where appropriate orientations) of the coding objects.

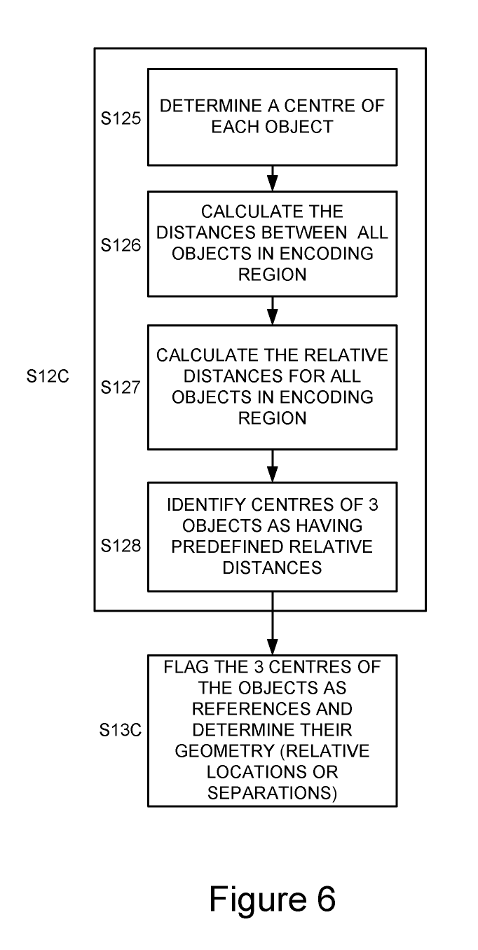

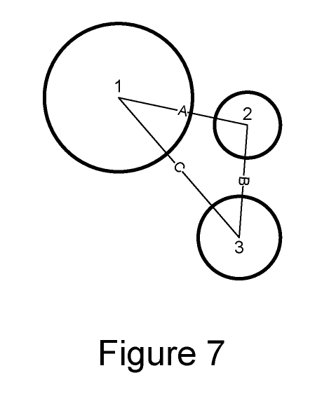

FIG. 6 is a partial flow diagram illustrating alternative steps for steps S12 and S13 in FIG. 3 and FIG. 7 illustrates the geometry used in this embodiment.

Step S12 in FIG. 3 is replaced with step S12C in this embodiment, which comprises three steps, S125, S126, S127 and S128. In step S125, a centre of each identified object in the encoded region is determined. In steps S126, the distances between the centre of all the objects is calculated as shown in FIG. 7. Three identified objects 1, 2 and 3 are shown and the distances between their centres is shown as A, B and C. In step S127, the relative distances between all of the objects is calculated to identify the centres of three objects having predefined relative distances. The relative differences can be calculated as A/B, A/C and B/C. The purpose of taking this relative difference is that the scaling (magnification) differences of the encoding region is compensated for. In step S128, the centres of the three objects are identified as having the predefined separation differences. In order for this to be possible, the spatial reference objects must be unique in relative separation and the encoding process must not encode the digital data to create three coding objects which have the same relative separation in the encoding area. This does provide a slight restriction on the encoding possibilities.

In step S13C, the centres of three extracted objects are defined as references and their geometry is determined. The geometry in this embodiment comprises their relative locations. The relative locations provide information on the orientation of the encoding region. The three reference objects lie in a triangle and the orientation of this triangle can be used as a reference coordinate system for the determination of the locations (and where appropriate orientations) of the coding objects.

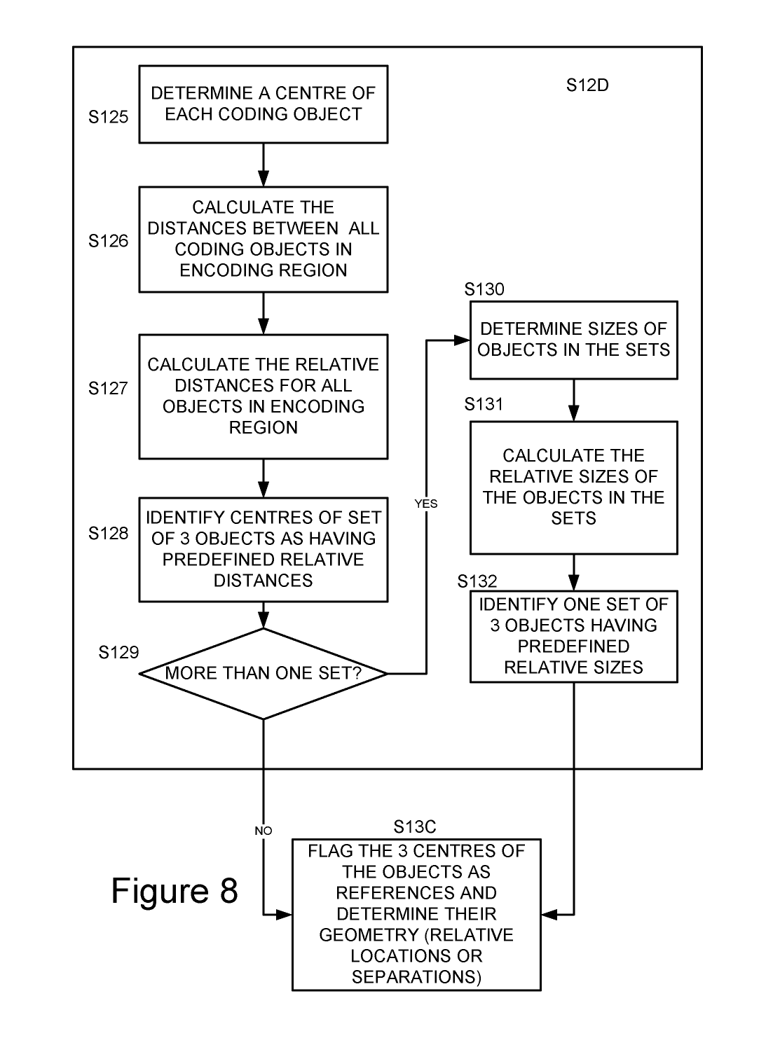

FIG. 8 is a partial flow diagram illustrating alternative steps for steps S12 and S13 in FIG. 3.

Step S12 in FIG. 3 is replaced with step S12D in this embodiment, which comprises the steps, S125 to S132. Steps S125 to S128 comprise the same steps as described with reference to FIG. 6. This embodiment is a variation of the embodiment of FIG. 6 in which the encoded objects are allowed to be encoded to have a relative separation that is the same as the reference objects. In this embodiment, the reference objects are additionally distinguished by their relative sizes in a manner similar to the embodiment described with reference to FIG. 5. In step S129 it is determined whether there are more than one set of three objects having the predefined relative distances and if so the process of FIG. 5 in steps S130 to S132 is implemented on the sets of objects.

In step S13C, the centres of three extracted objects are defined as references and their geometry is determined. The geometry in this embodiment comprises their relative locations and their relative sizes. The relative locations provide information on the orientation of the encoding region. The three reference objects lie in a triangle and the orientation of this triangle can be used as a reference coordinate system for the determination of the locations (and where appropriate orientations) of the coding objects.

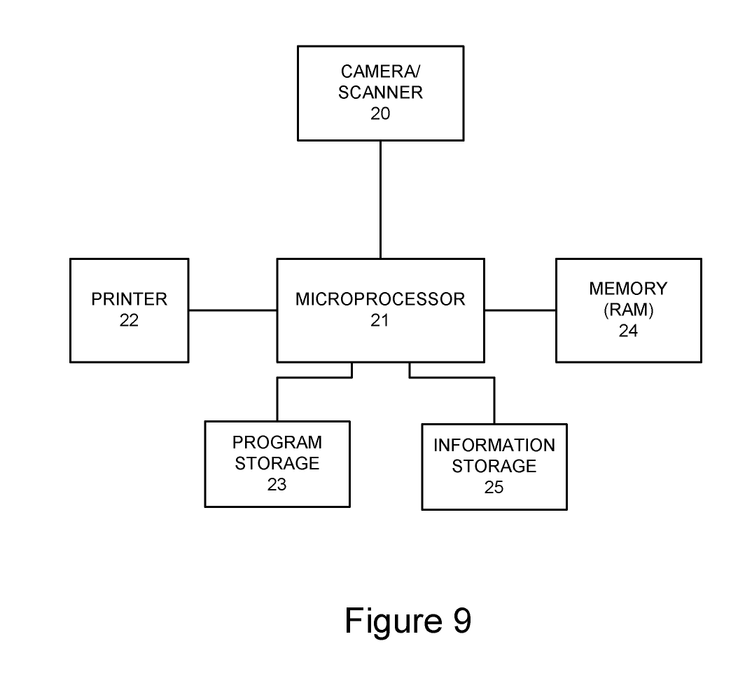

FIG. 9 illustrates a computer apparatus for implementing the process as herein before described.

A microprocessor 21 is connected to a Random Access Memory 24 for use by the microprocessor 21. A program storage 23 is connected to the processor to store the program code for controlling the microprocessor 21 to carry out the process. Information storage 25 is connected to the microprocessor 21 and stored the information (digital data) to be encoded or which has been decoded. A printer 22 is connected to the microprocessor in one embodiment where a physical copy of the encoded image is to be generated. A camera or scanner 20 is connected to the microprocessor 21 to capture an image containing the encoded region for processing by the microprocessor 21 to decode the information encoded in the encoded region. The computer apparatus can also be provided with a network connection such as the internet for accessing encoded images and for transmitting decoded information.

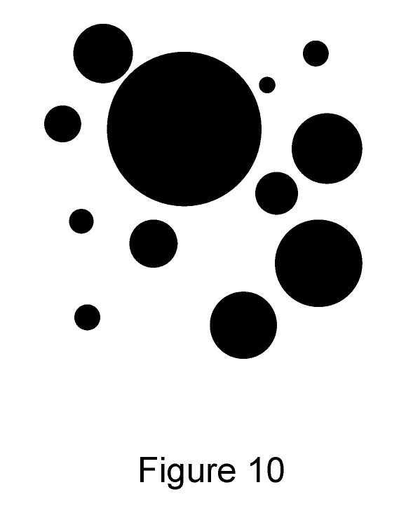

Alternative encoded regions generated by alternative encoding types will now be described with reference to FIGS. 10 to 16.

FIG. 10 illustrates an encoded region in an image in which the objects comprise solid circles of different sizes. In this embodiment, the coding parameters comprise the spatial relationship of the coding objects and the relative size of the coding objects. The reference objects are of the same shape as the coding objects in this embodiment and they can be distinguished either by their predetermined relative separations and/or by their predefined relative sizes. The boundary of the encoding region is not visible in this embodiment and null objects are not shown but can be used.

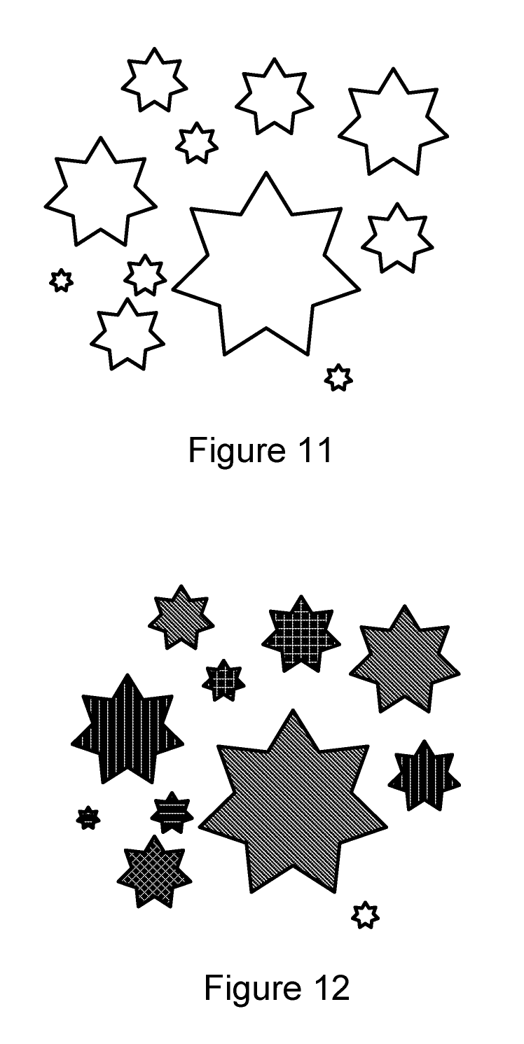

FIG. 11 illustrates an alternative embodiment which is like the embodiment of FIG. 10 except that the objects are a star shape rather than a circle.

FIG. 12 illustrates an alternative embodiment, which is like the embodiment of FIG. 11 except that the shapes are of different shades or colours. Hence in this embodiment, in addition to the coding parameters comprising the spatial relationship of the coding objects and the relative size of the coding objects, the coding parameters include the relative colours or shades of the coding objects. The reference objects are of the same shape as the coding objects in this embodiment and they can be distinguished by their predetermined relative separations, their relative colours or shades, and/or by their predefined relative sizes.

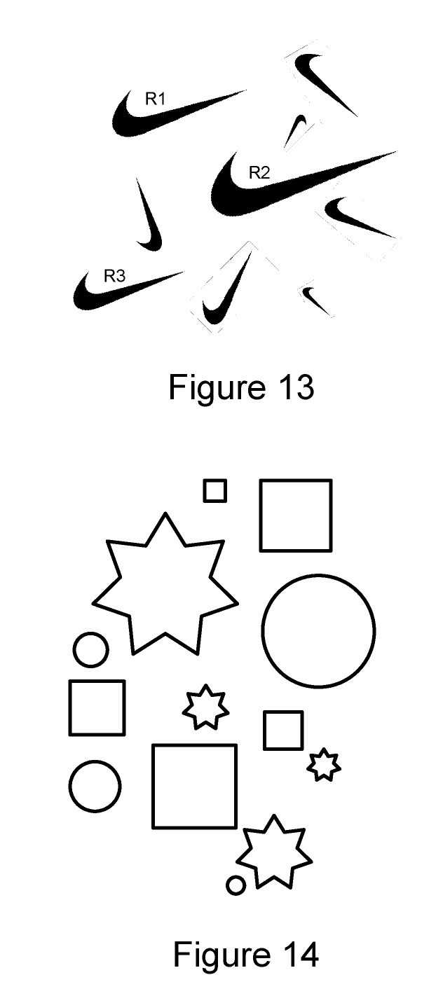

FIG. 13 illustrates another embodiment in which the objects used comprise a well known brand logo. The objects are spatially arranged with different sizes and with different relative orientations. Hence, in this embodiment, in addition to the coding parameters comprising the spatial relationship of the coding objects and the relative size of the coding objects, the coding parameters include the relative orientation of the coding objects. The reference objects are of the same shape as the coding objects in this embodiment and they can be distinguished by their predetermined relative separations, their relative orientations, and/or by their predefined relative sizes.

FIG. 14 illustrates another embodiment in which the objects used are different shapes although they could be different images or icons. The objects are spatially arranged with different sizes and of different shapes. Hence, in this embodiment, in addition to the coding parameters comprising the spatial relationship of the coding objects and the relative size of the coding objects, the coding parameters include the shape of the coding objects. The reference objects can be any shape as can the coding objects in this embodiment and they can be distinguished by their predetermined relative separations, their shapes, and/or by their predefined relative sizes.

FIG. 15 illustrates an embodiment in which the encoding region is in-filled with null objects. The pattern of coding and reference objects in this embodiment is the same as for the embodiment of FIG. 10. The encoding region is however populated between the coding and reference objects with null objects. In this embodiment the null objects are shown to be a different shade. They need not be. They can be the same colour or shade as the coding objects and the reference objects so that they are distinguished in the recognition process by their size or shape. In such an embodiment, the encoding parameters are restricted to avoid using the predetermined size reserved for the null objects. Alternatively, the null objects could be distinguished on any one of their colour or shade, shape, or orientation. Also, although only one type (i.e. the same shape, size and colour) of null object is shown in FIG. 15, any number of null object types can be used.

In this embodiment, the encoding region in which the objects are displayed is bounded by a boundary marker 20. The marker can be invisible or can comprise a line, pattern or device to enhance the appearance of the image. The shape of this and the null objects can be defined in the encoding process as discussed with reference to FIG. 2.

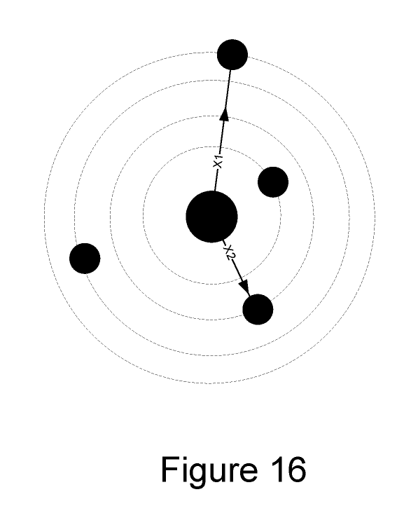

FIG. 16 illustrates an alternative embodiment in which the spatial reference configuration comprises a single reference object which defines a central point of symmetry in the encoding region. Coding objects can thus be arranged at radial positions around the reference object. Since the single reference object does not provide any angular reference, the only spatial coding parameters cannot include the angular position information. The relative location of the coding objects to the reference object can only be defined by a radial distance. Hence, the encoding takes the form of circumferential locations. Of course, the coding parameters could also include relative colour, relative orientation and relative size. This provides a simpler reference geometry but it has a reduced encoding capacity.

In this embodiment, the boundary can be defined for the encoding region as described above. Also, null codes can be defined and arranged in between the coding objects as described for the previous embodiments.

The following is a description of some generalized embodiments. Any embodiment can be used in combination with any other embodiment.

One aspect provides a method of generating an image to encode digital data to be computer readable, the method comprising defining a spatial reference object configuration within an encoding region; defining a shape and size of the encoding region by defining a boundary around the spatial reference object configuration; determining relative spatial properties for a plurality of coding objects to be displayed in the image based on the digital data and the spatial reference object configuration; and generating an image of the coding objects spatially arranged in the encoding region around the spatial reference object configuration in accordance with the determined spatial properties, wherein the spatial reference object configuration is distinctive compared to the coding objects.

In one embodiment, the relative spatial properties define dimensions in an encoding space into which the digital data can be encoded, with each unique digital data item being represented by unique point in the multidimensional space.

In one embodiment, the image is generated with the encoding region bounded by a visible boundary.

In one embodiment, null coding objects are defined to encode null data and the image is generated to form a predefined pattern using said null encoding objects in conjunction with the coding objects.

In one embodiment, the spatial reference object configuration comprises at least one reference object, wherein the at least one reference object is distinctive compared with the coding objects.

In one embodiment, the spatial reference object configuration comprises a single reference object defining a radially symmetric encoding space centred on the reference object, and the relative spatial properties for the coding objects is determined based at least on an angle and a distance relative to the reference object.

In one embodiment, the spatial reference object configuration comprises at least three reference objects having a defined spatial relationship, wherein the spatial relationship of the reference objects defines a coordinate space for the coding objects.

In one embodiment, the defined spatial relationship of the reference objects comprises a relative reference geometry.

In one embodiment, the reference objects have the same size, shape and colour.

In one embodiment, each reference object has a defined size relationship with the other reference objects.

In one embodiment, each reference object has a defined spatial relationship with the other reference objects.

In one embodiment, the relative spatial properties comprise at least one of relative position, relative size, relative shape, relative colour, relative orientation.

In one embodiment, the relative position is defined by angle and distance.

Another aspect provides a medium carrying a visible image encoding computer readable data, the image comprising a spatial reference object configuration within an encoding region, a plurality of coding objects spatially arranged around the spatial reference object configuration within the encoding region, a plurality of null codes within the encoding region, and a boundary around the encoding region, wherein the spatial relationship of the coding objects relative to the spatial reference object configuration encodes the data.

Another aspect provides a computer apparatus for generating an image to encode digital data to be computer readable, the apparatus comprising a program code store storing program code; and a processor for reading the program code in the code store; wherein the program code in the code store comprises code for controlling the processor to define a spatial reference object configuration within an encoding region; code for controlling the processor to define a shape and size of the encoding region by defining a boundary around the spatial reference object configuration; code for controlling the processor to determine relative spatial properties for a plurality of coding objects to be displayed in the image based on the digital data and the spatial reference object configuration; and code for controlling the processor to generate an image of the coding objects spatially arranged within the boundary of the encoding region around the spatial reference object configuration in accordance with the determined spatial properties, wherein the spatial reference object configuration is distinctive compared to the coding objects.

In one embodiment, the relative spatial properties define dimensions in an encoding space into which the digital data can be encoded, with each unique digital data item being represented by unique point in the multidimensional space.

In one embodiment, the code for controlling the processor to generate the image comprises code for controlling the processor to generate the image with the encoding region bounded by a visible boundary.

In one embodiment, null coding objects are defined to encode null data, and the code for controlling the processor to generate the image comprises code for controlling the processor to generate the image to form a predefined pattern using said null encoding objects in conjunction with the coding objects.

In one embodiment, the spatial reference object configuration comprises at least one reference object, wherein the at least one reference object is distinctive compared with the coding objects.

In one embodiment, the spatial reference object configuration comprises a single reference object defining a radially symmetric encoding space centred on the reference object, and code for controlling the processor to determine the relative spatial properties for the coding objects comprises code for controlling the processor to determine the relative spatial properties based at least on an angle and a distance relative to the reference object.

In one embodiment, the spatial reference object configuration comprises at least three reference objects having a defined spatial relationship, wherein the spatial relationship of the reference objects defines a coordinate space for the coding objects.

In one embodiment, the defined spatial relationship of the reference objects comprises a relative reference geometry.

In one embodiment, the reference objects have the same size, shape and colour.

In one embodiment, each reference object has a defined size relationship with the other reference objects.

In one embodiment, each reference object has a defined spatial relationship with the other reference objects.

In one embodiment, the relative spatial properties comprise at least one of relative position, relative size, relative shape, relative colour, relative orientation.

In one embodiment, the relative position is defined by angle and distance.

Another aspect of the invention provides a method of decoding digital data in an image, the method comprising analyzing the image to identify a distinctive spatial reference object configuration in an encoding region of the image, the shape and size of which is defined by a boundary around the spatial reference object configuration, the image comprising the spatial reference object configuration and coding objects in the coding region around the spatial reference object configuration; determining a spatial reference using the spatial reference object configuration; analyzing the image to identify a plurality of coding objects in the encoding region; determining relative spatial properties for the coding objects with reference to the spatial reference object configuration; and decoding the digital data from the spatial properties determined for the coding objects.

In one embodiment, the relative spatial properties define dimensions in an encoding space from which the digital data can be decoded, with each unique digital data item being represented by unique point in the multidimensional space.

In one embodiment, the encoding region is bounded by a visible boundary.

In one embodiment, null coding objects encode null data, the image has a predefined pattern using said null coding objects in conjunction with the coding objects, and the null coding objects are not used in the decoding of the digital data.

In one embodiment, the spatial reference object configuration comprises at least one reference object, wherein the at least one reference object is distinctive compared with the coding objects.

In one embodiment, the spatial reference object configuration comprises a single reference object defining a radially symmetric encoding space centred on the reference object, and the relative spatial properties for the coding objects is determined based at least on an angle and a distance relative to the reference object.

In one embodiment, the spatial reference object configuration comprises at least three reference objects having a defined spatial relationship, wherein the spatial relationship of the reference objects defines a coordinate space for the coding objects.

In one embodiment, the defined spatial relationship of the reference objects comprises a relative reference geometry.

In one embodiment, the reference objects have the same size, shape and colour.

In one embodiment, each reference object has a defined size relationship with the other reference objects.

In one embodiment, each reference object has a defined spatial relationship with the other reference objects.

In one embodiment, the relative spatial properties comprise at least one of relative position, relative size, relative shape, relative colour, relative orientation.

In one embodiment, the relative position is defined by angle and distance.

In one embodiment, the identification of the spatial reference object configuration comprises recognizing the spatial reference object configuration from among a plurality of known spatial reference object configurations, and controlling the determining, analyzing and decoding steps in dependence upon the spatial reference object configuration

Another aspect of the invention provides a computer apparatus for decoding digital data in an image, the computer apparatus comprising a program code store storing program code; and a processor for reading the program code in the code store; wherein the program code in the code store comprises code for controlling the processor to analyze the image to identify a distinctive spatial reference object configuration in an encoding region of the image, the shape and size of which is defined by a boundary around the spatial reference object configuration, the image comprising the spatial reference object configuration and coding objects in the coding region around the spatial reference object configuration; code for controlling the processor to determine a spatial reference using the spatial reference object configuration; code for controlling the processor to analyze the image to identify a plurality of coding objects in the encoding region; code for controlling the processor to determine relative spatial properties for the coding objects with reference to the spatial reference object configuration; and code for controlling the processor to decode the digital data from the spatial properties determined for the coding objects.

In one embodiment, the relative spatial properties define dimensions in an encoding space from which the digital data can be decoded, with each unique digital data item being represented by unique point in the multidimensional space.

In one embodiment, the encoding region is bounded by a visible boundary.

In one embodiment, null coding objects encode null data, the image has a predefined pattern using said null coding objects in conjunction with the coding objects, and the code for controlling the processor to decode the digital data does not use the null coding objects in the decoding of the digital data.

In one embodiment, the spatial reference object configuration comprises at least one reference object, wherein the at least one reference object is distinctive compared with the coding objects.

In one embodiment, the spatial reference object configuration comprises a single reference object defining a radially symmetric encoding space centred on the reference object, and the code for controlling the processor to determine the relative spatial properties for the coding objects comprises code for controlling the processor to determine the relative spatial properties for the coding objects based at least on an angle and a distance relative to the reference object.

In one embodiment, the spatial reference object configuration comprises at least three reference objects having a defined spatial relationship, wherein the spatial relationship of the reference objects defines a coordinate space for the coding objects.

In one embodiment, the defined spatial relationship of the reference objects comprises a relative reference geometry.

In one embodiment, the reference objects have the same size, shape and colour.

In one embodiment, each reference object has a defined size relationship with the other reference objects.

In one embodiment, each reference object has a defined spatial relationship with the other reference objects.

In one embodiment, the relative spatial properties comprise at least one of relative position, relative size, relative shape, relative colour, relative orientation.

In one embodiment, the relative position is defined by angle and distance.

In one embodiment, the code for controlling the processor to identify the spatial reference object configuration comprises code for controlling the processor to recognize the spatial reference object configuration from among a plurality of known spatial reference object configurations, and control the determining, analyzing and decoding in dependence upon the spatial reference object configuration

Another aspect provides a carrier medium such as a non-transient storage medium storing computer code for controlling a computer to carry out the method, or a transient medium carrying computer readable code for controlling a computer to carry out the method. Embodiments can be implemented in programmable digital logic that implements computer code. The code can be supplied to the programmable logic, such as a processor or microprocessor, on a carrier medium. One such form of carrier medium is a transient medium i.e. a signal such as an electrical, electromagnetic, acoustic, magnetic, or optical signal. Another form of carrier medium is a non-transitory medium that carries or stores the code, such as a solid-state memory, magnetic media (hard disk drive), or optical media (Compact disc (CD) or digital versatile disc (DVD)).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method of generating an image to encode digital data to be computer readable, the method comprising:
receiving a selection of a shape and size of an encoding region by selecting a boundary around a spatial reference object configuration;
determining relative spatial properties for a plurality of coding objects to be displayed in the image based on the digital data and the spatial reference object configuration; and
generating an image of the coding objects and the spatial reference object configuration, wherein the coding object and the spatial reference objects are spatially arranged within the boundary of the encoding region around the spatial reference object configuration in accordance with the determined spatial properties, wherein the spatial reference object configuration is visually distinctive compared to the coding objects.

2. A method according to claim 1, wherein the relative spatial properties define dimensions in an encoding space into which the digital data can be encoded, with each unique digital data item being represented by unique point in the encoding space.

3. A method according to claim 1, wherein the image is generated with the encoding region bounded by a visible boundary.

4. A method according to claim 1 wherein null coding objects are defined to encode null data, and the image is generated to form a predefined pattern using said null coding objects in conjunction with the coding objects within the encoding region.

5. A method according to claim 4, wherein the null coding objects have a similar visible appearance to the coding objects.

6. A method according to claim 1, wherein the spatial reference object configuration comprises at least one reference object, wherein the at least one reference object is distinctive compared with the coding objects.

7-12. (canceled)

13. A method according to claim 1, wherein the relative spatial properties comprise at least one of relative position, relative size, relative shape, relative colour, relative orientation.

14. A method according to claim 1, including receiving a selection of the spatial properties of coding objects to be used for encoding.

15. (canceled)

16. A method according to claim 1, including receiving a selection of the spatial reference object configuration within the encoding region.

17. A computer apparatus for generating an image to encode digital data to be computer readable, the apparatus comprising:
a program code store storing program code; and
a processor for reading the program code in the code store;
wherein the program code in the code store comprises:
code for controlling the processor to receive a selection of a shape and size of an encoding region by defining a boundary around a spatial reference object configuration;
code for controlling the processor to determine relative spatial properties for a plurality of coding objects to be displayed in the image based on the digital data and the spatial reference object configuration; and
code for controlling the processor to generate an image of the coding objects and the spatial reference object configuration, wherein the coding object and the spatial reference objects are spatially arranged within the boundary of the encoding region around the spatial reference object configuration in accordance with the determined spatial properties, wherein the spatial reference object configuration is visually distinctive compared to the coding objects.

18. A computer apparatus according to claim 17, wherein the relative spatial properties define dimensions in an encoding space into which the digital data can be encoded, with each unique digital data item being represented by unique point in the encoding space.

19. A computer apparatus according to claim 17, wherein the code for controlling the processor to generate the image comprises code for controlling the processor to generate the image with the encoding region bounded by a visible boundary.

20. A computer apparatus according to claim 17, wherein null coding objects are defined to encode null data, and the code for controlling the processor to generate the image comprises code for controlling the processor to generate the image to form a predefined pattern using said null encoding objects in conjunction with the coding objects within the encoding region.

21. A computer apparatus according to claim 20, wherein the code for controlling the processor to generate the image comprises code for controlling the processor to generate the null coding objects to have a similar visible appearance to the coding objects.

22. A computer apparatus according to claim 17, wherein the spatial reference object configuration comprises at least one reference object, wherein the at least one reference object is distinctive compared with the coding objects.

23-27. (canceled)

28. A computer apparatus according to claim 17, including code for controlling the processor to receive a selection of the spatial reference object configuration within the encoding region.

29. A computer apparatus according to claim 17 wherein the relative spatial properties comprise at least one of relative position, relative size, relative shape, relative colour, relative orientation.

30. A computer apparatus according to claim 17, including receiving a selection of the spatial properties of coding objects to be used for encoding.

31. A method of decoding digital data in an image, the method comprising:
analyzing the image to identify a distinctive spatial reference object configuration in an encoding region of the image, the shape and size of the encoding region being defined by a boundary around the spatial reference object configuration, the image comprising the spatial reference object configuration and coding objects in the encoding region around the spatial reference object configuration;
determining a spatial reference using the spatial reference object configuration;
analyzing the image to identify a plurality of coding objects in the encoding region;
determining relative spatial properties for the coding objects with reference to the spatial reference object configuration; and
decoding the digital data from the spatial properties determined for the coding objects;
wherein the identification of the spatial reference object configuration comprises recognizing the spatial reference object configuration from among a plurality of known spatial reference object configurations, and controlling the determining, analyzing and decoding steps in dependence upon the spatial reference object configuration.

32. A method according to claim 31, wherein the relative spatial properties define dimensions in an encoding space from which the digital data can be decoded, with each unique digital data item being represented by unique point in the multidimensional space.

33. A method according to claim 31, wherein the encoding region is bounded by a visible boundary.

34. A method according to claim 31, wherein null coding objects encode null data, the image has a predefined pattern using said null encoding objects in conjunction with the coding objects, and the null coding objects are not used in the decoding of the digital data.

35. A method according to claim 34, wherein the null coding objects have a similar visible appearance to the coding objects.

36-45. (canceled)

46. A computer apparatus for decoding digital data in an image, the computer apparatus comprising:
a program code store storing program code; and
a processor for reading the program code in the code store;
wherein the program code in the code store comprises:
code for controlling the processor to analyze the image to identify a distinctive spatial reference object configuration in an encoding region of the image, the shape and size of the encoding region being defined by a boundary around the spatial reference object configuration, the image comprising the spatial reference object configuration and coding objects in the coding region around the spatial reference object configuration;
code for controlling the processor to determine a spatial reference using the spatial reference object configuration;
code for controlling the processor to analyze the image to identify a plurality of coding objects in the encoding region;
code for controlling the processor to determine relative spatial properties for the coding objects with reference to the spatial reference object configuration; and
code for controlling the processor to decode the digital data from the spatial properties determined for the coding objects;
wherein the identification of the spatial reference object configuration comprises recognizing the spatial reference object configuration from among a plurality of known spatial reference object configurations, and controlling the determining, analyzing and decoding steps in dependence upon the spatial reference object configuration.

47. A computer apparatus according to claim 46, wherein the relative spatial properties define dimensions in an encoding space from which the digital data can be decoded, with each unique digital data item being represented by unique point in the multidimensional space.

48. A computer apparatus according to claim 46, wherein the encoding region is bounded by a visible boundary.

49. A computer apparatus according to claim 46, wherein null coding objects encode null data, the image has a predefined pattern using said null encoding objects in conjunction with the coding objects, and the code for controlling the processor to decode the digital data does not use the null coding objects in the decoding of the digital data.

50. A computer apparatus according to claim 49, wherein the null coding objects have a similar visible appearance to the coding objects.

51-60. (canceled)

61. A storage medium storing computer readable code for controlling a computer apparatus, the code comprising:
code for controlling the processor to receive a selection of a shape and size of an encoding region by defining a boundary around a spatial reference object configuration;
code for controlling the processor to determine relative spatial properties for a plurality of coding objects to be displayed in the image based on the digital data and the spatial reference object configuration; and
code for controlling the processor to generate an image of the coding objects and the spatial reference object configuration, wherein the coding object and the spatial reference objects are spatially arranged within the boundary of the encoding region around the spatial reference object configuration in accordance with the determined spatial properties, wherein the spatial reference object configuration is visually distinctive compared to the coding objects.

62. A storage medium storing computer readable code for controlling a computer apparatus, the code comprising:
code for controlling the processor to analyze the image to identify a distinctive spatial reference object configuration in an encoding region of the image, the shape and size of the encoding region being defined by a boundary around the spatial reference object configuration, the image comprising the spatial reference object configuration and coding objects in the coding region around the spatial reference object configuration;
code for controlling the processor to determine a spatial reference using the spatial reference object configuration;
code for controlling the processor to analyze the image to identify a plurality of coding objects in the encoding region;
code for controlling the processor to determine relative spatial properties for the coding objects with reference to the spatial reference object configuration; and
code for controlling the processor to decode the digital data from the spatial properties determined for the coding objects;
wherein the identification of the spatial reference object configuration comprises recognizing the spatial reference object configuration from among a plurality of known spatial reference object configurations, and controlling the determining, analyzing and decoding steps in dependence upon the spatial reference object configuration.
